(19) United States
(12) Patent Application Publication
(10) Pub. No.: US 2012/0099908 A1
(43) Pub. Date: Apr. 26, 2012

(54) SHEET TRANSPORT DEVICE IN THE PERIPHERY OF TRANSFER POSITION OF IMAGE FORMING APPARATUS

(75) Inventor: Atsushi YAMAZOE, Shizuoka (JP)

(73) Assignees: Toshiba Tec Kabushiki Kaisha, Tokyo (JP); Kabushiki Kaisha Toshiba, Tokyo (JP)

(21) Appl. No.: 13/224,229

(22) Filed: Sep. 1, 2011

Related U.S. Application Data
(60) Provisional application No. 61/406,984, filed on Oct. 26, 2010.

(51) Int. Cl. G03G 15/16; B65H 9/00

(52) U.S. Cl. 399/316; 271/226

(57) ABSTRACT

The sheet guide device according to the embodiments includes, an image carrier; a transfer body which faces the image carrier; and a pre-transfer guide which guides a recording medium to a facing area from under the facing area of the image carrier and the transfer body, and an end thereof on the facing area side is inclined with respect to a center line of the facing area.

### CROSS-REFERENCE TO RELATED APPLICATION

This application is based upon and claims the benefit of priority from Provisional U.S. Application 61/406,984 filed on Oct. 26, 2010, the entire contents of which are incorporated herein by reference.

### FIELD

Embodiments described herein relate generally to a sheet guide device which guides a sheet to a transfer unit at the same time as an image is formed using developer, which is formed on an image carrier of an image forming apparatus such as a copy machine, a printer, or the like.

### BACKGROUND

In the related art, in an image forming apparatus such as a copy machine, a printer, or the like of an electro photography-type, there is a device which guides a sheet in a vertical direction using a guide and transports the sheet to a nip between an image carrier and a transfer device.

However, if a total rear end of the sheet is separated from a guide at the same time at a nip between the image carrier and the transfer device, while a toner image on the image carrier is transferred to the sheet, a transport speed of the sheet temporally changes, when a repulsive force is large, which is generated when the rear end of the sheet separates from the guide. When the transport speed of the sheet changes during performing a transfer operation, there is a concern that a transfer failure, such as transfer missing, may occur.

### BRIEF DESCRIPTION OF THE DRAWINGS

FIG. 1 is a schematic configuration diagram for showing a color MFP, according to a first embodiment;

FIG. 2 is a perspective view which schematically shows an end portion of a pre-transfer guide on the transfer side, according to the first embodiment;

FIG. 3 is a plan view which schematically shows the end portion of the pre-transfer guide;

FIG. 4 is an explanatory diagram for showing a state where a rear end of a sheet is separated from the pre-transfer guide according to the first embodiment;

FIG. 5 is an explanatory diagram for showing a time when a rear side of the rear end of the sheet is separated from the pre-transfer guide;

FIG. 6 is a perspective view which schematically shows an end portion of a transfer unit side of a pre-transfer guide according to a second embodiment;

FIG. 7 is a schematic plan view for showing the end portion of the transfer unit side of the pre-transfer guide;

FIG. 8 is a schematic configuration diagram for showing a monochrome MFP according to a third embodiment;

FIG. 9 is a perspective view which schematically shows an end portion of a transfer unit side of a pre-transfer guide according to a third embodiment; and

FIG. 10 is an explanatory diagram for showing a time when a rear side of a rear end of a sheet is separated from the pre-transfer guide according to the third embodiment.

### DETAILED DESCRIPTION

According to the embodiment, a sheet guide apparatus includes, an image carrier; a transfer body which faces the image carrier; and a pre-transfer guide which guides a recording medium to a facing area from under the facing area of the image carrier and the transfer body, and one end portion of the facing area side is inclined with respect to a center line of the facing area.

Hereinafter, embodiments will be described.

### First Embodiment

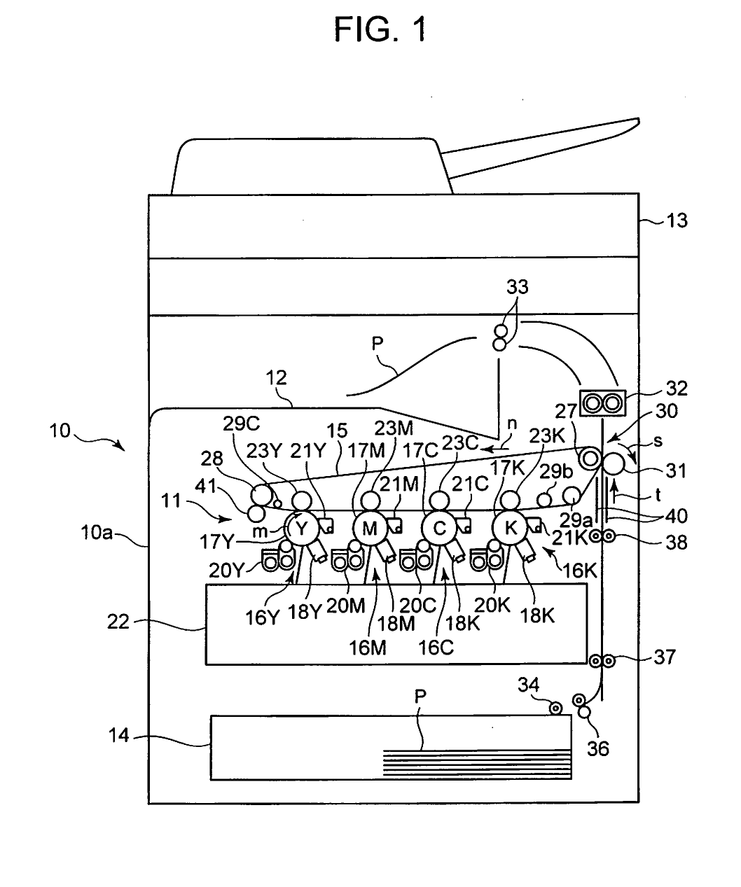

FIG. 1 shows a color MFP (Multi-Functional Peripheral) 10 which is an image forming apparatus according to a first embodiment. For example, the MFP 10 includes a printer unit 11 which forms an image, a sheet discharging unit 12 which accommodates a sheet P which is a recording medium to be discharged from the printer unit 11, a scanner unit 13 which reads images, and a sheet feeding unit 14 which feeds the sheet P.

The printer unit 11 includes four sets of image forming stations 16Y, 16M, 16C, and 16K of Y(yellow), M (magenta), C (cyan), and K (black) which constitute an image forming unit. The four sets of image forming stations 16Y, 16M, 16C, and 16K of Y(yellow), M (magenta), C (cyan), and K (black) are disposed in parallel along a downstream side of an intermediate transfer belt 15 which is an image carrier, and an intermediate transfer member. Each image forming station, 16Y, 16M, 16C, and 16K includes respectively photoconductive drums 17Y, 17M, 17C, and 17K.

Each image forming station 16Y, 16M, 16C, and 16K includes, chargers 18Y, 18M, 18C, and 18K; developing devices 20Y, 20M, 20C, and 20K which are developing units; and photo conductor cleaners 21Y, 21M, 21C, and 21K, in the periphery of the photoconductive drums 17Y, 17M, 17C, and 17K which rotate in the direction of an arrow m. The printer unit 11 includes a laser exposure device 22 which constitutes the image forming unit.

The laser exposure device 22 irradiates each photoconductive drum 17Y, 17M, 17C, and 17K with respective laser light beams which correspond to each color, while the photoconductive drums 17Y, 17M, 17C, and 17K rotate from the chargers 18Y, 18M, 18C, and 18K in the periphery thereof to the developing devices 20Y, 20M, 20C, and 20K. The laser exposure device 22 irradiates laser light and forms an electrostatic latent image on the photoconductive drum 17Y, 17M, 17C, and 17K.

The printer unit 11 includes a backup roller 27 and a driven roller 28 which support the intermediate transfer belt 15, and allows the intermediate transfer belt 15 to travel in the direction of an arrow n. The printer unit 11 includes tension rollers 29a, 29b, and 29c which apply tension to the intermediate transfer belt 15. The printer unit 11 includes respective primary transfer rollers 23Y, 23M, 23C, and 23K in a position which faces the respective photoconductive drums 17Y, 17M, 17C, and 17K, through the intermediate transfer belt 15.

Each primary transfer roller 23Y, 23M, 23C, and 23K primarily transfers toner images which are images formed by developer, and are formed on the photoconductive drums 17Y, 17M, 17C, and 17K, to the intermediate transfer belt 15 to be overlapped. Each photo conductor cleaner 21Y, 21M, 21C, and 21K removes and collects residual toner on each photoconductive drum 17Y, 17M, 17C, and 17K, after the primary transfer.

The printer unit 11 includes a secondary transfer roller 31 which is a transfer body, in a position facing the backup roller 27, through the intermediate transfer belt 15. The secondary transfer roller 31 is driven by the intermediate transfer belt 15 to rotate in the direction of an arrow s. The printer unit 11 forms a transfer unit 30 which is a facing area where the intermediate transfer belt 15 and the secondary transfer roller 31 face each other. The transfer unit 30 forms a transfer bias at a nip between the intermediate transfer belt 15 and the secondary transfer roller 31, and performs a secondary transfer.

The printer unit 11 includes a pickup roller 34, a pair of separation rollers 36, a pair of transporting rollers 37, a pair of resist rollers 38, and a pre-transfer guide 40 between the sheet feeding unit 14 which accommodates sheets P and the transfer unit 30.

The printer unit 11 separates the sheet P which is extracted from the sheet feeding unit 14, one by one, using the separation rollers 36, and transports the sheets to the pair of resist rollers 38, using the pair of transporting rollers 37. The printer unit 11 puts a front end of the sheet P in order, in the pair of resist rollers 38, and then transports the sheet P to the transfer unit 30, through a pre-transfer guide 40 on the upper side. The printer unit 11 transports the sheet P from the pair of resist rollers 38 to the transfer unit 30, in a substantially vertical direction.

The printer unit 11 collectively performs a secondary transfer of the toner image formed on the intermediate transfer belt 15, to the sheet P which is transported from the pair of resist rollers 38, in the transfer unit 30. The printer unit 11 fixes the toner image to the sheet P in a fixing device 32, and discharges the sheet P to the sheet discharging unit 12, using a pair of discharging rollers 33. The printer unit 11 removes the residual toner of the intermediate transfer belt 15, using a belt cleaner 41, after the secondary transfer.

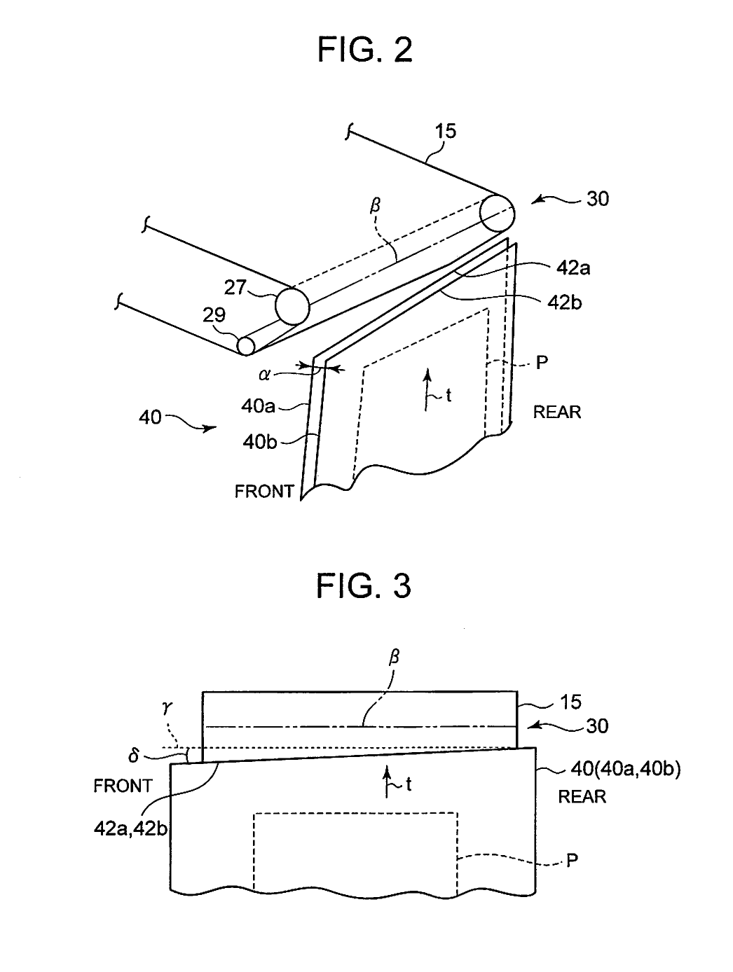

The pre-transfer guide 40 will be described. The pre-transfer guide 40, as shown in FIGS. 2 and 3, includes a first guide plate 40a and a second guide plate 40b which is a pair of guide plates having a gap of a guiding path a through which the sheet P passes. End portions 42a and 42b of the first guide plate 40a and the second guide plate 40b on the transfer unit 30 side, are inclined with respect to a center line β of the transfer unit 30, as shown in FIGS. 2 and 3. The center line β of the transfer unit 30 means the center of a nip between the intermediate transfer belt 15 and the secondary transfer roller 31 of the transfer unit 30.

As shown in FIG. 3, the end portions 42a and 42b of the first guide plate 40a and the second guide plate 40b are inclined, for example, by an angle δ with respect to a parallel line γ of the center line β of the transfer unit 30. The first guide plate 40a and the second guide plate 40b are inclined so that, for example, the front side of a main body 10a of the MFP 10 becomes lower than the rear side thereof. In addition, the pre-transfer guide 40 may be inclined so that the rear side of the main body 10a of the MFP 10 becomes lower than the front side thereof.

The pair of resist rollers 38 transports the sheet P in the direction of an arrow t, when the toner image of the intermediate transfer belt 15 reaches the transfer unit 30. The sheet P is guided by the pre-transfer guide 40, and reaches the transfer unit 30. The transfer unit 30 transfers the toner image on the intermediate transfer belt 15 to the sheet P which passes through the nip between the intermediate transfer belt 15 and the secondary transfer roller 31. A rear end Pb of the sheet P separates from the pre-transfer guide 40, while the toner image is secondarily transferred to the sheet P, in the transfer unit 30.

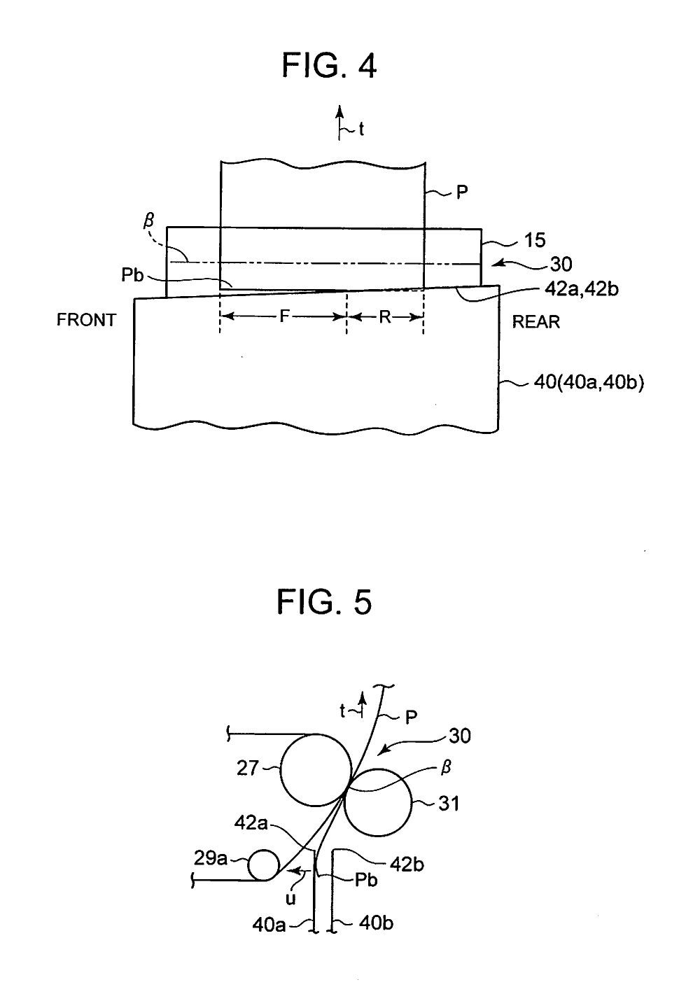

Since the front side of the pre-transfer guide 40 is inclined with respect to the center line β of the transfer unit 30 so that the front side is lower than the rear side, the rear end Pb of the sheet P slowly separates from the pre-transfer guide 40. The rear end Pb of the sheet P slowly separates from the pre-transfer guide 40 from the front side to the rear side. For example, as shown in FIG. 4, even though an area (F) on the front side of the rear end Pb of the sheet P starts to separate from the pre-transfer guide 40, an area (R) on the rear side is guided by the pre-transfer guide 40. Thereafter, if the sheet P is further transported in the direction of the arrow t, the rear side of the rear end Pb of the sheet P separates from the pre-transfer guide 40, as well, accordingly the total width of the rear end Pb of the sheet P is separated from the pre-transfer guide 40.

When the rear side of the rear end Pb of the sheet P separates from the pre-transfer guide 40, as shown in FIG. 5, the rear side of the rear end Pb of the sheet P slightly bounces in the direction of an arrow u which returns the sheet P to a planar shape, due to the elasticity of the sheet P. However, when the rear side of the rear end Pb of the sheet P bounces in the direction of the arrow u, the repulsive force generated in the sheet P is small, therefore, there is no concern that the transport speed of the sheet P will change. The sheet P maintains a uniform transport speed, even when the total width of the rear end Pb of the sheet P separates from the pre-transfer guide 40. There is no concern that the transport speed of the sheet P will change during transferring in the transfer unit 30, and the toner image on the intermediate transfer belt 15 is favorably secondarily transferred to the sheet P.

According to the first embodiment, the end portions 42a and 42b of the first guide plate 40a and the second guide plate 40b are inclined with respect to the center line β of the transfer unit 30. According to the first embodiment, the rear end Pb of the sheet P slowly separates from the pre-transfer guide 40 toward the rear side from the front side during transferring the toner image on the intermediate transfer belt 15 to the sheet P, in the transfer unit 30. It is possible to prevent the transport speed of the sheet P from changing in the middle of the transfer operation in the transfer unit 30. It is possible to obtain a desirable transfer, by suppressing a transfer failure such as image missing due to a change in the transport speed of the sheet P during transferring.

### Second Embodiment

Subsequently, a second embodiment will be described. The second embodiment has a different guide structure, compared to the above described first embodiment. In the second embodiment, the same configuration as that of the first embodiment described above will be denoted by the same reference numerals, and the description thereof will be omitted.

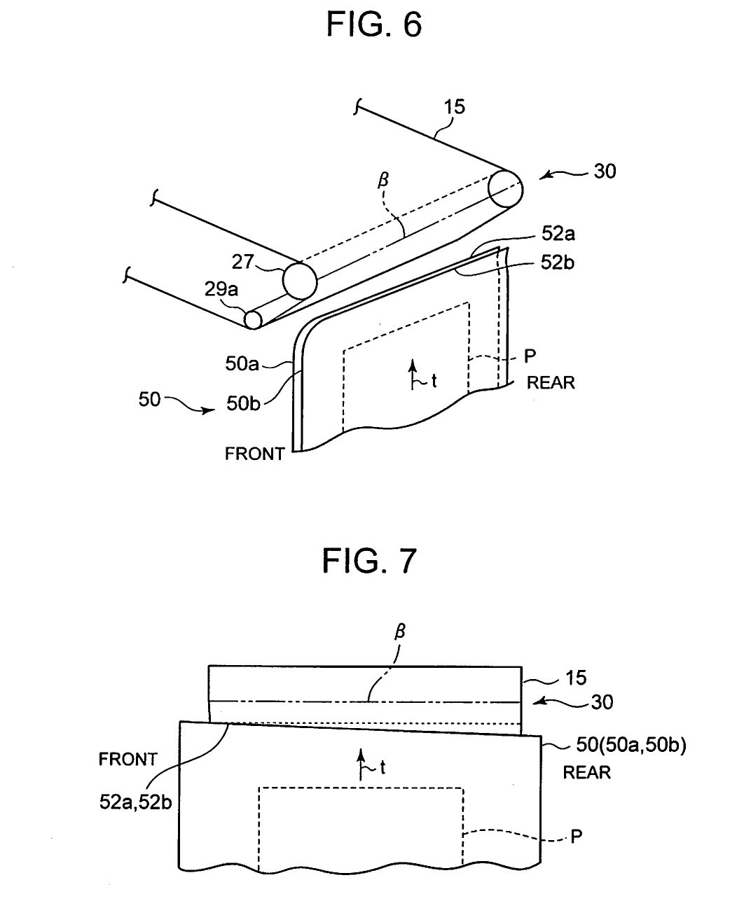

In the second embodiment, as shown in FIG. 6, a pre-transfer guide 50 which includes a first guide plate 50a and a second guide plate 50b, curves along an intermediate transfer belt 15. End portions 52a and 52b of the first guide plate 50a and the second guide plate 50b are inclined with respect to a center line β of a transfer unit 30, as shown in FIGS. 6 and 7. As shown in FIG. 7, the end portions 52a and 52b of the first guide plate 50a and the second guide plate 50b are inclined so that, for example, a rear side of a main body 10a of an MFP 10 becomes lower than the front side.

A rear end Pb of the sheet P separates from the pre-transfer guide 50, during secondarily transferring the toner image to the sheet P, in the transfer unit 30. The rear end Pb of the sheet P slowly separates from the pre-transfer guide 50 toward the front side from the rear side of the pre-transfer guide 50, since the pre-transfer guide 50 is inclined with respect to the center line β of the transfer unit 30 so that the rear side becomes lower than the front side.

The front side of the rear end Pb of the sheet P slightly bounces in a direction where the sheet P returns to a planar shape, due to the elasticity of the sheet P, when the front side of the rear end Pb of the sheet P is separated from the pre-transfer guide 50 and the entire width of the rear end Pb of the sheet P is separated from the pre-transfer guide 50. However, since the repulsive force which is generated in the sheet P is small, when the front side of the rear end Pb of the sheet P bounces, there is no concern that the transport speed of the sheet P will change. It is possible to maintain a uniform transport speed of the sheet P, even when the total width of the rear end Pb of the sheet P separates from the pre-transfer guide 50. There is no concern that the transport speed of the sheet P will change during transferring in the transfer unit 30, and the toner image on the intermediate transfer belt 15 is favorably secondarily transferred to the sheet P.

According to the second embodiment, similarly to the first embodiment, the rear end Pb of the sheet P slowly separates from the pre-transfer guide 50 from the rear side to the front side, in the middle of transferring the toner image on the intermediate transfer belt 15 to the sheet P. The transport speed of the sheet P is prevented from changing in the middle of the transfer operation in the transfer unit 30. In the middle of the transfer operation, it is possible to obtain a desirable transfer by suppressing a transfer failure such as image missing due to a change in the transport speed of the sheet P.

### Third Embodiment

Subsequently, a third embodiment will be described. The third embodiment relates to a pre-transfer guide of a monochrome MFP, for example. In the third embodiment, the same configuration as that of the second embodiment described above will be denoted by the same reference numerals, and the descriptions thereof will be omitted.

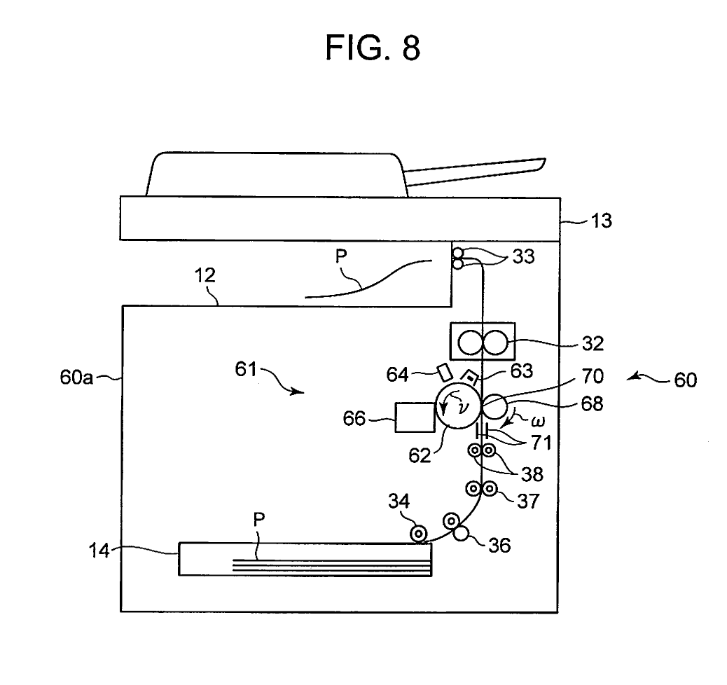

A printer unit 61 of a monochrome-type MFP 60 shown in FIG. 8, which is an image forming apparatus according to the third embodiment, includes a charger 63, an exposure device 64, a developing device 66, and a monochrome transfer roller 68 which is a transfer body, in the periphery of a photoconductive drum 62 which is an image carrier which rotates in the direction of an arrow v. The charger 63 and the exposure device 64 and the developing device 66 constitute an image forming unit which forms a toner image to the photoconductive drum 62.

The monochrome transfer roller 68 rotates in the direction of an arrow w according to the driving of the photoconductive drum 62. The printer unit 61 forms a transfer unit 70 which is a facing area of the photoconductive drum 62 and the monochrome transfer roller 68. The transfer unit 70 forms a transfer bias at a nip between the photoconductive drum 62 and the monochrome transfer roller 68, and transfers the toner image on the photoconductive drum 62 to a sheet P.

The charger 63 of the printer unit 61 uniformly charges the photoconductive drum 62, and the exposure device 64 forms an electrostatic latent image on the photoconductive drum 62, by irradiating the photoconductive drum with light. The developing device 66 supplies toner to the electrostatic latent image on the photoconductive drum 62, using, for example, a K (black) toner and a two-component developer formed of a carrier, and makes the electrostatic latent image visible.

The printer unit 61 is provided with a pre-transfer guide 71 between a pair of resist rollers 38 and the transfer unit 70. The printer unit 61 puts the front ends of the sheets P which are taken out from a sheet feeding unit 14 in order, in the pair of resist rollers 38, and then transports the sheets P to the transfer unit 70 through the pre-transfer guide 71.

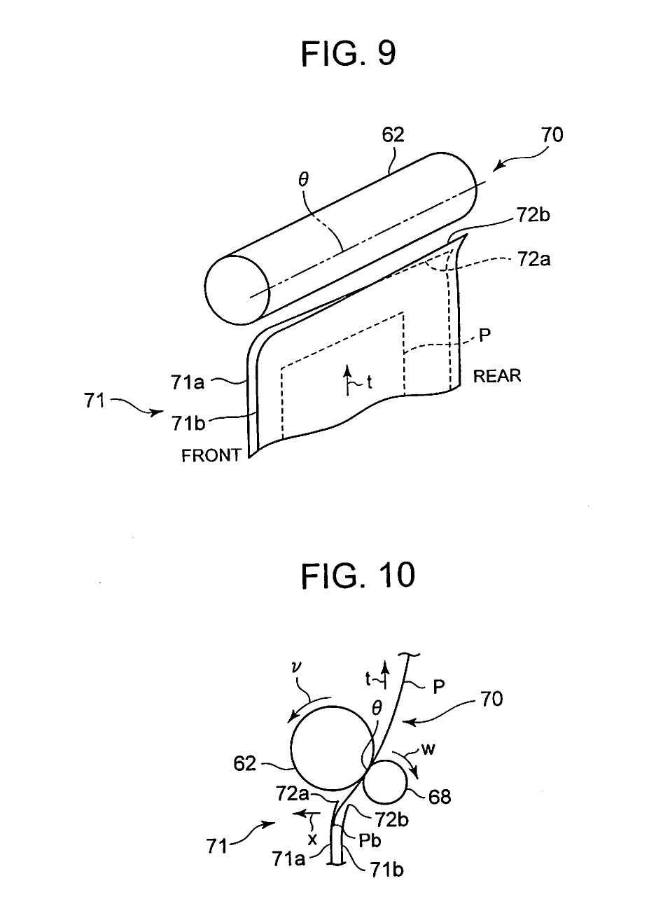

The pre-transfer guide 71, as shown in FIG. 9, includes a first guide plate 71a and a second guide plate 71b which curves along the photoconductive drum 62. An end portion 72a of the first guide plate 71a on the transfer unit 70 side is inclined with respect to a center line θ of the transfer unit 70, as shown in FIG. 9. The center line θ of the transfer unit 70 is the center of the nip between the photoconductive drum 62 of the transfer unit 70 and the monochrome transfer roller 68.

The end portion 72a of the first guide plate 71a on the transfer unit 70 side, is inclined so that, for example, the rear side of a main body 60a of the MFP 60 is lower than the front side, and an end portion 72b of the second guide plate 71b on the transfer unit 70 side is parallel to the center line θ of the transfer unit 70.

The sheet P which is transported to the transfer unit 70, along the pre-transfer guide 71, is going to return to a planar shape due to elasticity. The sheet P moves to return to the planar shape in the pre-transfer guide 71, and leans in the direction of an arrow x.

In the transfer unit 70, a rear end Pb of the sheet P separates from the pre-transfer guide 71 while the toner image formed on the photoconductive drum 62 is transferring to the sheet P. The rear end Pb of the sheet P which leans on the first guide plate 71a side slowly separates from the pre-transfer guide 71 from the rear side to the front side, along the first guide plate 71a.

The front side of the rear end Pb of the sheet P slightly bounces in the direction of the arrow x due to the elasticity of the sheet P, when the front side of the rear end Pb of the sheet P is separated from the pre-transfer guide 71 and the total width of the rear end Pb of the sheet P separates from the pre-transfer guide 71. However, since the repulsive force which is generated in the sheet P is small, there is no concern that the transport speed of the sheet P will change, when the front side of the rear end Pb of the sheet P bounces in the direction of the arrow x. Even when the total width of the rear end Pb of the sheet P separates from the pre-transfer guide 71, the sheet P maintains a uniform transport speed. There is no concern that the transport speed of the sheet P will change during transferring in the transfer unit 70, and the toner image on the photoconductive drum 62 is favorably transferred to the sheet P.

According to the third embodiment, the rear end Pb of the sheet P slowly separates from the pre-transfer guide 71 from the rear side to the front side, along the first guide plate 71a, in the middle of transferring the toner image on the photoconductive drum 62 to the sheet P. The fluctuation in the transport speed of the sheet P is prevented in the middle of the transfer operation in the transfer unit 70. It is possible to obtain a desirable transfer by suppressing a transfer failure such as image missing due to a change in the transport speed of the sheet P, in the middle of the transfer operation.

According to at least one embodiment which is described above, it is possible to suppress the fluctuation in the transport speed of a recording medium in the middle of the transfer operation, when the total width of the rear end of the recording medium separates from the guide. It is possible to obtain a desirable transfer by suppressing a transfer failure due to the fluctuation of the transport speed of the sheet P in the middle of the transfer operation.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A sheet guide device comprising:
an image carrier;
a transfer body which faces the image carrier; and
a pre-transfer guide which guides a recording medium to a facing area from under the facing area of the image carrier and the transfer body, and of which an end portion on the facing area side is inclined with respect to a center line of the facing area.

2. The device according to claim 1,
wherein the image carrier is an intermediate transfer member which carries an image formed using a developer, which is primarily transferred from a photoconductive drum, and faces the recording medium.

3. The device according to claim 1,
wherein the image carrier is the photoconductive drum.

4. The device according to claim 1,
wherein the transfer body is a transfer roller which forms a nip between the image carrier and the transfer body.

5. The device according to claim 1,
wherein the pre-transfer guide guides the recording medium to the facing area, in a vertical direction.

6. The device according to claim 5,
wherein the end portion of the pre-transfer guide on the facing area side curves.

7. The device according to claim 6,
wherein the pre-transfer guide includes a pair of guide plates which face each other through a guiding path of the recording medium interposed between the guiding path, and an end portion of the guide plate on the facing area side, on which at least a rear end of the recording medium leans, is inclined with respect to a center line of the facing area.

8. An image forming apparatus comprising:
an image carrier;
an image forming unit which forms an image using a developer, in the image carrier;
a transfer body which faces the image carrier; and
a pre-transfer guide which guides a recording medium to a facing area from under the facing area of the image carrier and the transfer body and of which an end portion on the facing area side is inclined with respect to a center line of the facing area.

9. The apparatus according to claim 8,
wherein the image forming unit includes a plurality of photoconductive drums and a plurality of image forming parts which respectively forms the image using a developer to the plurality of photoconductive drums, and
wherein the image carrier is an intermediate transfer member which carries a plurality of images formed using the developer, which is primarily transferred from the plurality of photoconductive drums, and faces the recording medium.

10. The apparatus according to claim 8,
wherein the image carrier is the photoconductive drums.

11. The apparatus according to claim 8,
wherein the transfer body is a transfer roller which forms a nip between the image carrier and the transfer body.

12. The apparatus according to claim 8,
wherein the pre-transfer guide guides the recording medium to the facing area, in a vertical direction.

13. The apparatus according to claim 12,
wherein the end portion of the pre-transfer guide on the facing area side curves.

14. The apparatus according to claim 13,
wherein the pre-transfer guide includes a pair of guide plates which faces each other through a guiding path of the recording medium interposed between the guiding path, and an end portion of the guide plate on the facing area side, on which at least a rear end of the recording medium leans, is inclined with respect to a center line of the facing area.

15. A method of guiding a sheet comprising:
guiding a recording medium to a facing area of an image carrier and a transfer body; and
slowly releasing a rear end of the recording medium from the guide while transferring an image of the image carrier, which is formed using a developer, to the recording medium, in the facing area.
